(19) United States
(12) Patent Application Publication
(10) Pub. No.: US 2024/0234896 A9
(43) Pub. Date: Jul. 11, 2024

(54) TRACTION BATTERY AND METHOD FOR PRODUCING A TRACTION BATTERY

(71) Applicant: Dr. Ing. h.c. F. Porsche Aktiengesellschaft, Stuttgart (DE)

(72) Inventors: Hubert Stadtfeld, Bretten (DE); Gregor Wolf, Stuttgart (DE); Marco Augustdörfer, Leonberg (DE)

(73) Assignee: Dr. Ing. h.c. F. Porsche Aktiengesellschaft, Stuttgart (DE)

(21) Appl. No.: 18/489,094

(22) Filed: Oct. 18, 2023

(30) Foreign Application Priority Data
Oct. 19, 2022 (DE) 10 2022 127 422.5

(51) Int. Cl. H01M 50/24; H01M 50/249

(52) U.S. Cl. CPC H01M 50/24; H01M 50/249; H01M 2220/20

(57) ABSTRACT

A traction battery with a battery housing and a plurality of battery cells arranged in the battery housing. At least one flame-retardant plate is arranged in the battery housing and separates two housing chambers from one another. A plate receiving structure with at least one groove pair including two opposite grooves is present in the battery housing. The at least one flame-retardant plate is held in the battery housing by the plate receiving structure. Also described is a method for producing such a traction battery.

### CROSS-REFERENCE TO RELATED APPLICATION

This application claims priority to German Patent Application No. 10 2022 127 422.5, filed Oct. 19, 2022, the content of such application being incorporated by reference herein in its entirety.

### FIELD OF THE INVENTION

The present invention relates to a traction battery, in particular to a traction battery for a fully electric or hybrid-electric motor vehicle, with a battery housing and a plurality of battery cells arranged in the battery housing, wherein at least one flame-retardant plate is arranged in the battery housing which separates two housing chambers from one another. The present invention furthermore relates to a method for producing such a traction battery.

### BACKGROUND OF THE INVENTION

DE 10 2021 109 239 A1, which is incorporated by reference herein, discloses a traction battery of the aforementioned type, wherein four flame-retardant plates are arranged in the battery housing, which form five housing chambers, wherein several battery cells are arranged in each housing chamber. However, the traction battery described has a relatively complex structure and therefore requires a relatively complex assembly.

### SUMMARY OF THE INVENTION

The traction battery according to the present invention comprises a generally liquid-tight, preferably gas-tight, battery housing. The battery housing generally comprises several housing parts fastened to one another. Typically, the battery housing consists at least partially of a metal.

The traction battery according to aspects of the invention comprises a plurality of battery cells, which are arranged in the battery housing. Typically, the battery cells are substantially plate-shaped or cuboid-shaped and arranged parallel to one another. The battery cells each comprise two typically metallic connection elements for electrically contacting the respective battery cell, wherein the connection elements are preferably arranged on opposite end sides of the respective battery cell.

The traction battery according to aspects of the invention comprises at least one flame-retardant plate, which is arranged in the battery housing and separates two housing chambers from one another. Preferably, several flame-retardant plates are arranged in the battery housing and form several housing chambers separated from one another. At least one battery cell is arranged in each of the housing chambers. Preferably, in each case a single battery cell stack comprising several battery cells is arranged in each housing chamber, wherein all battery cells of a battery cell stack are arranged parallel to one another adjacent to one another in one spatial direction and are aligned with one another.

According to aspects of the invention, a plate receiving structure, which has at least one groove pair consisting of two opposite grooves, is present in the battery housing of the traction battery, wherein the at least one flame-retardant plate is held in the battery housing by the plate receiving structure. Specifically, each flame-retardant plate is held via the opposite grooves of one groove pair of the plate receiving structure. Preferably, the typically elongate flame-retardant plates are respectively held via their longitudinal edges in the opposite grooves of the plate receiving structure. During assembly of the traction battery according to aspects of the invention, the flame-retardant plates can be inserted into the battery housing in a simple manner via the grooves. Preferably, all grooves are parallel to one another and respectively extend parallel to a housing edge of the battery housing so that all flame-retardant plates can be inserted into the battery housing from a single housing side. Preferably, a groove width of the grooves approximately corresponds to a thickness of the flame-retardant plates so that the flame-retardant plates in the assembled state are held fixedly, i.e., largely play-free, in the grooves. This creates a mechanically robust and furthermore relatively tight connection between the at least one flame-retardant plate and the plate receiving structure. It is also conceivable that a plate-shaped compression element together with a flame-retardant plate is respectively held at least in some grooves of the plate receiving structure. In this case, the groove width of these grooves preferably corresponds to about an overall thickness of a flame-retardant plate and a compression element. Advantageously, the plate receiving structure and the at least one flame-retardant plate are designed in such a way that several at least liquid-tight, preferably gas-tight, housing chambers that are separate from one another are formed within the battery housing. This enables, for example, a relatively simple and well controllable introduction of a filling material into the housing chambers. Furthermore, the fluid-tight housing chambers may, for example, also be filled or flowed through in a simple manner with an electrically non-conductive, heat-conducting fluid.

The plate receiving structure according to aspects of the invention with at least one groove pair for receiving the at least one flame-retardant plate therefore enables the realization of a traction battery that can be assembled relatively simply.

Preferably, at least a subset of the grooves of the plate receiving structure is formed by the battery housing. Preferably, at least all grooves arranged on a same battery housing side, i.e., a respective groove of each groove pair, particularly preferably all grooves of the plate receiving structure, are formed by the battery housing so that no additional components need to be provided for the plate receiving structure on at least one battery housing side, preferably on both opposite battery housing sides. This enables the realization of a particularly easy-to-assemble traction battery.

In a preferred embodiment of the invention at least a subset of the grooves of the plate receiving structure is formed by a frame structure arranged in the battery housing. Preferably, the frame structure forms all grooves of the plate receiving structure that are arranged on a same battery housing side, i.e., in each case a groove of each groove pair. Particularly preferably, there are two frame structures that are arranged on opposite battery housing sides and respectively form all grooves of the plate receiving structure that are arranged on the respective battery housing side, i.e., a respective one of the two grooves of each groove pair. Particularly preferably, the two frame structures in this case have a substantially identical design and are arranged, rotated by 180° relative to one another, in the battery housing. Preferably, the at least one frame structure is an injection-molded part or is produced from a metal sheet, for example a deep drawing part or a stamped and bent part. Via the at least one separate frame structure, differently configured plate receiving structures in a predetermined battery housing can be realized in a simple manner by inserting differently designed frame structures.

Preferably, the at least one frame structure is held by at least a subset of the battery cells so that no additional holding means need to be provided to hold the at least one frame structure. Preferably, the frame structure comprises several substantially planar support surfaces, which are arranged between the grooves and respectively abut on at least one battery cell.

A particularly easy-to-assemble traction battery can be realized by the battery housing in a preferred embodiment comprising a housing part that is designed as a hollow profile, which forms four of the six outer surfaces of the battery housing. In this case, the hollow profile is preferably produced by extrusion molding.

Typically, the traction battery comprises a cell carrier element to which the connection elements of at least a subset of the battery cells are fastened. Preferably, the cell carrier element has at least one groove into which the at least one flame-retardant plate is inserted, preferably with an end side. As a result, the at least one flame-retardant plate is particularly reliably fastened in the battery housing. Furthermore, relatively well-sealed housing chambers can thereby be realized in a simple manner. Moreover, the cell carrier element is supported by the typically several flame-retardant plates at several supporting points, whereby a particularly robust traction battery can be realized.

A relatively good flame-retardant effect can be achieved by having the at least one flame-retardant plate in a preferred embodiment consist of a fiber-reinforced plastic, particularly preferably of a flame-retardant duromer or thermoplastic with a mineral fiber reinforcement.

Alternatively, a relatively good flame-retardant effect can be achieved by having the at least one flame-retardant plate in an alternative, preferred embodiment consist of a multilayer composite, particularly preferably of a multilayer composite with a mineral cover layer.

Preferably, the at least one flame-retardant plate has a mineral coating in order to achieve a particularly good flame-retardant effect.

Typically, at least one elastically deformable compression element is arranged in the battery housing in order to avoid the battery cells sliding in the battery housing despite the temperature-dependent volume change generally present in battery cells. Preferably, the at least one compression element is formed plate-shaped and held in the battery housing by the plate receiving structure. This makes it possible to insert the at least one compression element, analogously to the at least one flame-retardant plate, in a simple manner into the battery housing during assembly. The compression elements can in this case be held separately in grooves of the plate receiving structure or can also be held together with a flame-retardant plate in grooves of the plate receiving structure. In the first case, either a compression element or a flame-retardant plate is respectively arranged in a groove of the plate receiving structure, whereas a compression element and a flame-retardant plate are arranged together in a groove of the plate receiving structure in the second case. Furthermore, it is also conceivable to produce at least one flame-retardant plate from an elastically deformable material so that the flame-retardant plate also forms a compression element.

In a preferred embodiment, a flame-retardant plate and/or a plate-shaped compression element is respectively arranged between two adjacent battery cells in relation to at least one spatial direction. This creates a particularly reliable traction battery.

Preferably, housing chambers in which at least one of the plurality of battery cells is arranged respectively contain a heat-conducting medium in order to enable an advantageous temperature control of the battery cells.

According to aspects of the invention, the plurality of battery cells, the at least one flame-retardant plate and a frame structure forming the plate receiving structure are pre-assembled outside the battery housing and are subsequently inserted as a pre-assembled unit into the battery housing. The pre-assembly outside the traction battery housing enables a relatively simple assembly of the traction battery.

### BRIEF DESCRIPTION OF THE DRAWINGS

The present invention is explained below in greater detail with reference to the appended figures. The following are shown:

FIG. 1 schematically shows a plan view of a portion of a traction battery according to aspects of the invention cut in a longitudinal plane,

FIG. 2 schematically shows a cross section of a first embodiment of the traction battery according to aspects of the invention, and

FIG. 3 schematically shows a cross section of a second embodiment of the traction battery according to aspects of the invention.

### DETAILED DESCRIPTION OF THE INVENTION

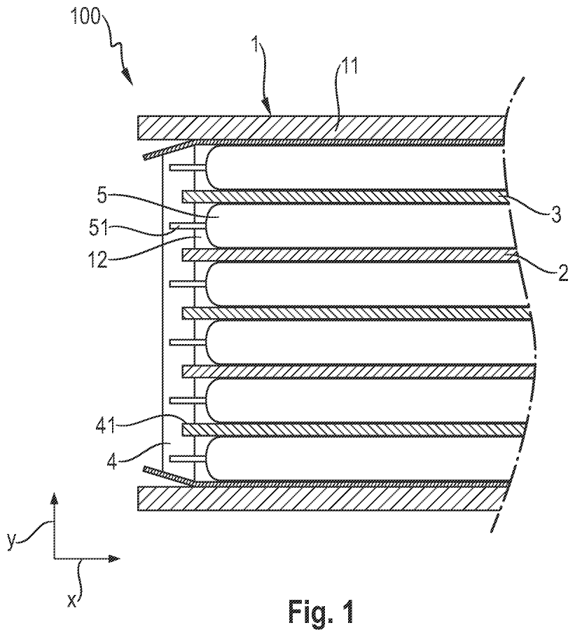

FIG. 1 shows a plan view, i.e., a representation perpendicular to a plane spanned by a longitudinal direction x and a width direction y, of a traction battery 100.

The traction battery 100 comprises a substantially cuboid-shaped battery housing 1, which comprises a housing part 11 designed as a hollow profile, wherein the housing part 11 forms the two housing sides perpendicular to the transverse direction y and the two housing sides perpendicular to a height direction z. The housing part 11 is preferably an extrusion-molded part.

In the present embodiment example, two flame-retardant plates 2 as well as three plate-shaped compression elements 3 are arranged in the battery housing 1 in such a way that a plate plane of the flame-retardant plates 2 and of the plate-shaped compression elements 3 respectively extends perpendicularly to the width direction y. The flame-retardant plates 2 preferably consist of a fiber-reinforced plastic or of a multilayer composite and preferably have a mineral coating and/or a mineral fiber reinforcement. The plate-shaped compression elements 3 consist of an elastically deformable material.

The flame-retardant plates 2 and the plate-shaped compression elements 3 are respectively held in the battery housing 1 via a plate receiving structure 6, wherein the plate receiving structure 6 respectively has one groove pair 62 per flame-retardant plate 2 and per plate-shaped compression elements 3. Each groove pair 62 respectively hereby consists of two grooves 61, which are arranged opposite to one another, here opposite to one another in relation to the height direction z.

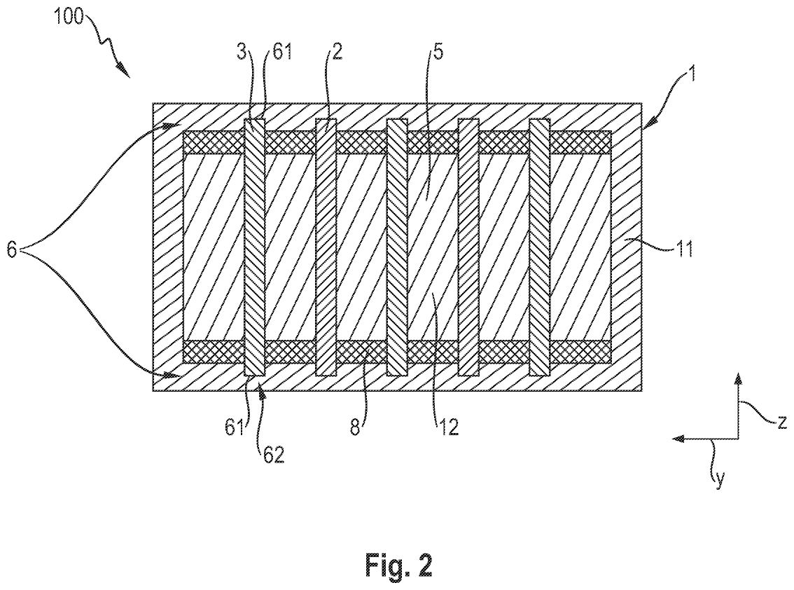

In the embodiment of the traction battery 100 shown in FIG. 2, all grooves 61 of the plate receiving structure 6 are formed by the battery housing 1.

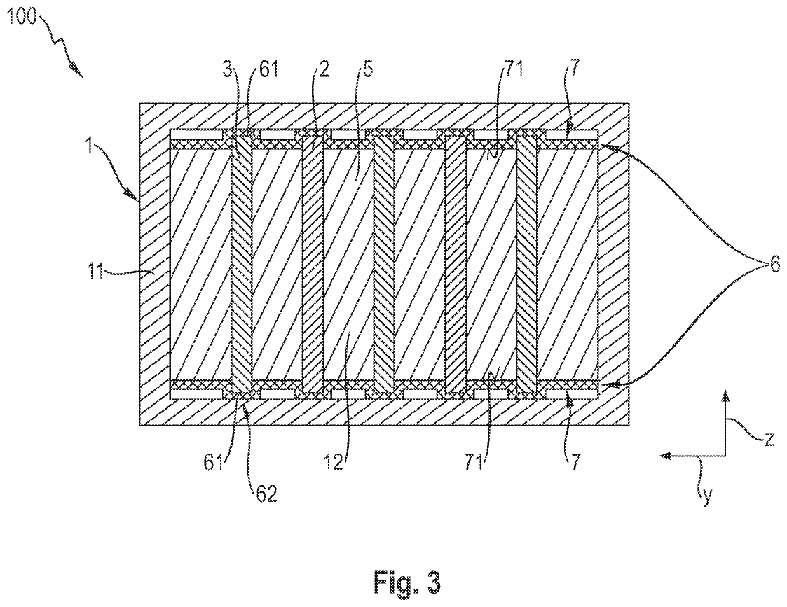

In the alternative embodiment of the traction battery 100 shown in FIG. 3, the grooves 61 are formed by two frame structures 7 arranged in the battery housing 1, wherein each frame structure 7 forms a respective groove 61 of each of the groove pairs 62. The two frame structures 7 in this case are configured to be substantially identical and are arranged, rotated by 180° relative to one another, on opposite sides of the battery cells 5. The two frame structures 7 respectively comprise several support surfaces 71, which respectively abut on at least one battery cell 5 so that the two frame structures 7 are held by the battery cells 5.

An end side of the flame-retardant plates 2 and of the plate-shaped compression elements 3 is respectively inserted into a groove 41 of a cell carrier element 4 which is arranged in the battery housing 1 and extends parallel to the width direction y.

Six elongate housing chambers 12 adjacent to one another in relation to the width direction y are formed in the battery housing 1 by the flame-retardant plates 2 and the plate-shaped compression elements 3, wherein the flame-retardant plates 2 and the plate-shaped compression elements 3 respectively separate two adjacent housing chambers 12 from one another. A longitudinal direction of the housing chambers 12 runs parallel to a longitudinal direction of the battery housing 1.

At least one elongate battery cell 5 is respectively arranged in each of the six housing chambers 12 in such a way that a longitudinal direction of the battery cells 5 is parallel to a longitudinal direction of the battery housing 1. Consequently, either a flame-retardant plate 2 or a plate-shaped compression element 3 is respectively arranged between two battery cells 5 adjacent to one another in relation to the width direction y. The battery cells 5 respectively have a connection element 51, which is fastened to the cell carrier element 4.

In the embodiment of the traction battery 100 shown in FIG. 2, interstices located on both sides of the battery cells 5 between the battery cells 5 and the battery housing 1 are filled with a filling material 8, the sides being opposite to one another in relation to the height direction. Furthermore, in the two embodiments of the traction battery 100 shown, the housing chambers 12 preferably contain an electrically non-conductive liquid heat-conducting medium (not shown here), which is filled into the housing chambers 12 or which flows through the housing chambers 12 during the operation of the traction battery 100.

In the embodiment of the traction battery 100 shown in FIG. 3, the battery cells 5, the flame-retardant plates 2, the plate-shaped compression elements 3 and the frame structure 7 are preferably pre-assembled outside the battery housing 1 and subsequently inserted as a pre-assembled unit into the battery housing 1.

### LIST OF REFERENCE NUMBERS

100 Traction battery
1 Battery housing
11 Housing part
12 Housing chambers
2 Flame-retardant plates
3 Plate-shaped compression elements
4 Cell carrier element
41 Grooves
5 Battery cells
51 Connection elements
6 Plate receiving structure
61 Grooves
62 Groove pairs
7 Frame structures
71 Support surfaces
8 Filling material

What is claimed is:

1. A traction battery comprising:
a battery housing and a plurality of battery cells arranged in the battery housing,
at least one flame-retardant plate arranged in the battery housing that separates the battery housing into two housing chambers, and
a plate receiving structure disposed in the battery housing, the plate receiving structure including at least one groove pair having two opposite grooves,
wherein the at least one flame-retardant plate is held in the battery housing by the plate receiving structure.

2. The traction battery according to claim 1, wherein at least a subset of the grooves of the plate receiving structure is formed by the battery housing.

3. The traction battery according to claim 1, wherein at least a subset of the grooves of the plate receiving structure is defined by a frame structure arranged in the battery housing.

4. The traction battery according to claim 3, wherein the frame structure is held by at least a subset of the battery cells.

5. The traction battery according to claim 1, wherein the battery housing comprises a housing part in the form of a hollow profile.

6. The traction battery according to claim 1, further comprising a cell carrier element to which connection elements of at least a subset of the battery cells are fastened, wherein the cell carrier element has at least one groove into which the at least one flame-retardant plate is inserted.

7. The traction battery according to claim 1, wherein the at least one flame-retardant plate comprises a fiber-reinforced plastic.

8. The traction battery according to claim 1, wherein the at least one flame-retardant plate comprises a multilayer composite.

9. The traction battery according to claim 1, wherein the at least one flame-retardant plate has a mineral coating.

10. The traction battery according to claim 1 further comprising at least one plate-shaped compression element arranged in the battery housing and held in the battery housing by the plate receiving structure.

11. The traction battery according to claim 1, wherein the flame-retardant plate and/or a plate-shaped compression element is/are respectively arranged between two adjacent battery cells of the plurality of battery cells in relation to at least one spatial direction.

12. The traction battery according to claim 1, wherein the housing chambers, in which at least one battery cell of the plurality of battery cells is arranged, respectively contain a heat-conducting medium.

13. A method for producing a traction battery, said method comprising:
pre-assembling, outside of a battery housing, a plurality of battery cells, at least one flame-retardant plate and a plate receiving structure, and
subsequently inserting the pre-assembled unit into the battery housing,
wherein the at least one flame-retardant plate divides the battery housing into two housing chambers,
wherein the plate receiving structure includes at least one groove pair having two opposite grooves,
wherein the at least one flame-retardant plate is held in the battery housing by the plate receiving structure.
